(19) United States
(12) Patent Application Publication
(10) Pub. No.: US 2007/0255496 A1
(43) Pub. Date: Nov. 1, 2007

(54) Methods and systems for incorporating global-positioning-system information into a data recording

(76) Inventors: Chee Keat Fong, Cypress, TX (US); Wai-tlan Tan, Palo Alto, CA (US)

Correspondence Address: HEWLETT-PACKARD COMPANY;Intellectual Property Administration, P.O. Box 272400, Fort Collins, CO, 80527-2400, US

(21) Appl. No.: 11/415,259

(22) Filed: Apr. 30, 2006

(51) Int. Cl. G01M 17/00; G01C 21/00

(52) U.S. Cl. 701/213; 701/35

(57) ABSTRACT

Various embodiments of the present invention are directed to methods and systems for incorporating global-positioning-system information into a data recording. In one embodiment of the present invention, a data encoder encodes received data and outputs the encoded data to a data track. A global-positioning-system encoder encodes received global-positioning-system data and outputs the encoded global-positioning-system-data to a global-positioning-system track. Interconnected decision logic selects which global-positioning-system data is output.

### TECHNICAL FIELD

The present invention relates to data recordings, and, in particular, to methods and systems for incorporating global-positioning-system information into a media recording.

### BACKGROUND OF THE INVENTION

Recent advances in electronics have provided widespread availability of various types of data recording devices. One type of data recording device is a video recorder. Video recorders can exist as stand-alone devices, or can be integrated into multi-purpose electronic devices, such as cellular phones and personal digital assistants. The time duration of a video recording can vary tremendously, from a few seconds recorded in less that one hundred frames to an hour or more, recorded in hundreds of thousands of frames. Likewise, the subject matter of a video, often correlated with the location of which the video is recorded, may vary tremendously. For example, a video recording can consist of just a few frames of video recorded at a single location during a small continuous time interval, or many hundreds of thousands of frames of video recorded over many months at many different locations.

Some video-recorder users are interested in creating a record of the precise time and location at which portions of a video recording, or video frames, are created. Currently, a video recording can be modified to incorporate global positioning system (“GPS”) information, such as time and location of recorded events. GPS is a satellite navigation system that uses a number of GPS satellites to broadcast precise timing signals. An electronic GPS receiver receives the precise timing signals from one or more of the GPS satellites at known locations and uses the time delays in receiving the timing signals to determine the location of the GPS receiver. The received timing signals can be used for various time-sensitive applications, including telecommunications, seismology, time-synchronization systems, time-code generators, and other time-sensitive applications.

Currently, GPS information can be incorporated into a video recording by modifying a video signal to include the GPS information in each frame of the video signal for the duration of the video recording. FIG. 1 illustrates a recorded video frame containing overlaid GPS information. Video frame 100 includes a recorded image of the sun 102 and overlaid GPS information 104. The overlaid GPS information 104 includes the time 106, latitude 108, longitude 110, and elevation 112 at which the video frame 100 was recorded. Video frame 100 represents one frame of a video recording that contains multiple frames. The overlaid GPS information 104 is incorporated into each video frame of the associated video recording and is continuously updated as the GPS information changes during recording.

Providing continuously overlaid GPS information in a video recording can be useful when GPS information is of primary importance in a video recording, such as when recording scientific experiments in which precise timing and/or location of events depicted in a video recording are crucial, such as monitoring the movements of an animal in the animal's natural environment. However, continuously overlaying GPS information throughout an entire video recording has a number of disadvantages. The GPS information may obscure a portion of the recorded image. Additionally, the displayed GPS information cannot be temporarily removed. For many video-recorder users, the obtrusiveness of the continuously overlaid GPS information greatly exceeds the benefit of having the GPS information available.

Another disadvantage associated with continuously overlaying GPS information onto a video recording is that, once the GPS information is overlaid, additional time and processing power may be needed for subsequent processing of the video signal, because both the GPS information and the video signal, are incorporated into a single signal, and may need to be processed together even when only the original video signal is needed. Manufacturers, distributors, retailers, and users of video recorders have, therefore, recognized a need for methods and systems to unobtrusively incorporate GPS information into a video recording without increasing the amount of time and power needed for processing of the video signal or the GPS information.

### SUMMARY OF THE INVENTION

Various embodiments of the present invention are directed to methods and systems for incorporating global-positioning-system information into a data recording. In one embodiment of the present invention, a data encoder encodes received data and outputs the encoded data to a data track. A global-positioning-system encoder encodes received global-positioning-system data and outputs the encoded global-positioning-system-data to a global-positioning-system track. Interconnected decision logic selects which global-positioning-system data is output.

### BRIEF DESCRIPTION OF THE DRAWINGS

FIG. 1 illustrates a recorded video frame containing overlaid GPS information.

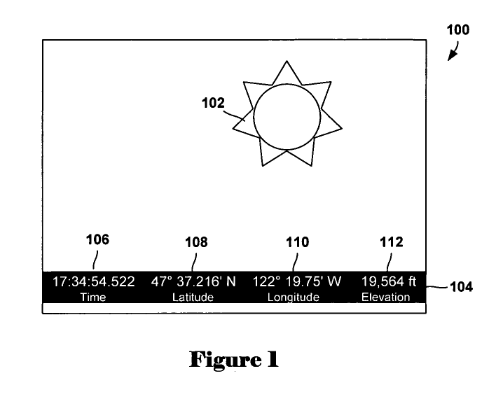

FIG. 2 shows a schematic representation of a video recorder that includes a multiplexer with two signal inputs and a single output that represents one embodiment of the present invention.

FIGS. 3A-3C show a control-flow diagram for a routine “storing GPS-information” performed by a video recorder that represents one embodiment of the present invention.

FIG. 4A illustrates a GPS-information display for a selected video frame that represents one embodiment of the present invention.

FIG. 4B illustrates a GPS-information display that includes an image of a selected video frame and reliable corresponding GPS information that represents one embodiment of the present invention.

FIG. 4C illustrates a GPS-information display that includes an image of a selected video frame and unreliable corresponding GPS information that represents one embodiment of the present invention.

FIG. 5 illustrates three GPS information displays overlain on a map that represents one embodiment of the present invention.

### DETAILED DESCRIPTION OF THE INVENTION

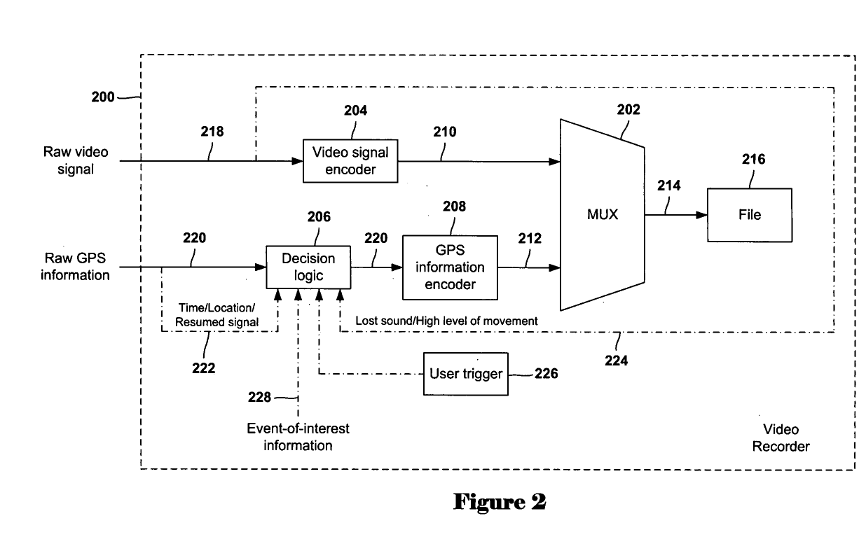

Various embodiments of the present invention are directed to methods and systems for incorporating global-positioning-system (“GPS”) information into a data recording. FIG. 2 shows a schematic representation of a video recorder that includes a multiplexer with two signal inputs and a single output that represents one embodiment of the present invention. Video recorder 200 includes a multiplexer 202, a video-signal encoder 204, decision logic 206, and a GPS-information encoder 208. Multiplexer 202 receives a video signal via a video-signal input 210 and GPS information via a GPS input 212, and outputs a multi-track signal 214 that stores information output from the multiplexer 202 into a file 216 as separate tracks for storage and subsequent retrieval.

A raw video signal 218 is input to the video-signal encoder 204 for processing and compression of the raw video signal 218. The processed and compressed video signal 210 is output from the video-signal encoder 204 and input to the multiplexer 202. Raw GPS information 220 is output from an interconnected GPS receiver (not shown in FIG. 2) and input to decision logic 206. When a GPS-information-storing event occurs, the raw GPS information 220 is output from the decision logic 206 and input to the GPS-information encoder 208 for processing. The processed GPS information 212 is then output from the GPS-information encoder 208 and input to the multiplexer 202. Note that the GPS-information encoder 208 can be powered down between successive GPS-information-storing events.

GPS-information-storing events, or “storing events,” are generally events that indicate that the previous GPS information input to the multiplexer 202 may no longer reflect the current GPS information, and accordingly, new GPS information should be input to the multiplexer 202. Storing-event detection can occur by providing a number of input signals to the decision logic 206. Each input signal provides a current value for one or more monitored events which may be useful in determining when GPS information should be stored. In one embodiment of the present invention, when the current value for one or more of the monitored events either exceeds a predetermined maximum threshold value or falls below a predetermined minimum threshold value, the raw GPS information 220 is transmitted to the GPS-information encoder 208.

There are several events which may indicate that the previously-stored GPS information may need to be updated. In FIG. 2, decision logic 206 receives signals from four monitored-event inputs: a raw GPS-information input 222, a raw video-signal input 224, a video-recorder-user-controlled storing-event trigger 226, and an event-of-interest input 228. The raw GPS-information input 222 contains several different types of information that can be used to determine when a storing event should occur, including the amount of time between the current raw GPS information and the most recent stored information, the distance traversed between the current raw GPS information and the most recent stored information, and the regaining of a previously lost GPS signal. The raw video-signal input 224 also contains several different types of information that can be used to determine when a storing event should occur, including resumed sound after an extended silence and the occurrence of a high level of motion. The video-recorder-user-controlled storing-event trigger 226 can be used by a video-recorder user to manually trigger a storing event, and can be implemented in a number of different ways, such as a button that a video-recorder user can press when he or she desires to mark a particular scene in a video recording with GPS information. The event-of-interest input 228 may include information received from one or more of a number of different sources that provide information to determine when GPS information is stored.

The multi-track signal 214 is output from the multiplexer 202 and input to file 216. When one or more storing events occur, multi-track signal 214 includes a video signal from the video-signal input 210 and the corresponding GPS information from the GPS input 212. The GPS information can be stored as metadata in any of a number of common exchange formats, including 3GP, MPEG-1, MPEG-2, and MPEG-4. For example, file 216 can include 3GP and MP4 file formats. Video signal and GPS information can be stored as separate tracks in separate locations in the file 216, with the GPS information stored as metadata in a user-data area of the 3GP/MPEG-4 file. Each track can contain a different index that stores information on how to read back the stored data. Each track also can contain a different timing index indicating the times for each video frame, audio frame, and storing event. Note that the 3GP/MPEG-4 file can contain GPS information from multiple storing events.

The GPS information can be accessed either in conjunction with the corresponding video recording or accessed separately from the video recording. The video recording and GPS information contained in the file can be accessed and viewed locally by the video recorder, or viewed by another electronic device, or attached to an email, or accessed and viewed by some other action. Additionally, the video signal can be viewed on a separate viewing device that lacks the ability to access the GPS information.

Once a video recording is stored into a file, a video-recorder user can play back the video recording. Likewise, once GPS information is stored into the file, the video-recording user can access GPS information for selected frames of the video recording. The GPS information can be displayed to the video-recorder user in a GPS-information display. The reliability of the GPS information contained on the GPS-information display may depend on several factors, including the reliability of the acquisition of the GPS information and the amount of time between the selected video frame and the most recent storing of GPS information.

The reliability of the acquisition of the GPS information is indicated in the raw GPS information. The raw GPS information being encoded includes three types of information: current time, current location, and GPS-reading reliability. The GPS-reading reliability information determines whether a GPS-reading is current. For example, a GPS signal may be lost when a video-recorder user loses a GPS signal when entering a tunnel. In one embodiment of the present invention, the GPS-information reliability information is a binary value indicating whether the GPS reading at the time of a storing event is current. During the storing event, when attempts to acquire GPS information fail, the reading reliability is set to zero, indicating that the GPS reading is unreliable. In one embodiment of the present invention, the reliability of the acquired GPS signal is stored in the file along with the current time and the current location. The reliability of the acquired GPS signal can be stored in a number of different ways, including by using a sliding scale of reliability, or by using a “Reliable” or “Not Reliable” determination.

Reliability of the GPS signal can also be related to the amount of time that has elapsed between the current time and the most recent storing event. Time gaps may exist between successive storing events that make the displayed GPS information potentially unreliable. For example, when a video-recorder user accesses GPS information a half second after the most recent storing event, the displayed GPS information is most likely reliable. However, when a video-recorder user accesses GPS information eight seconds after the most recent storing event, the displayed GPS information is potentially unreliable.

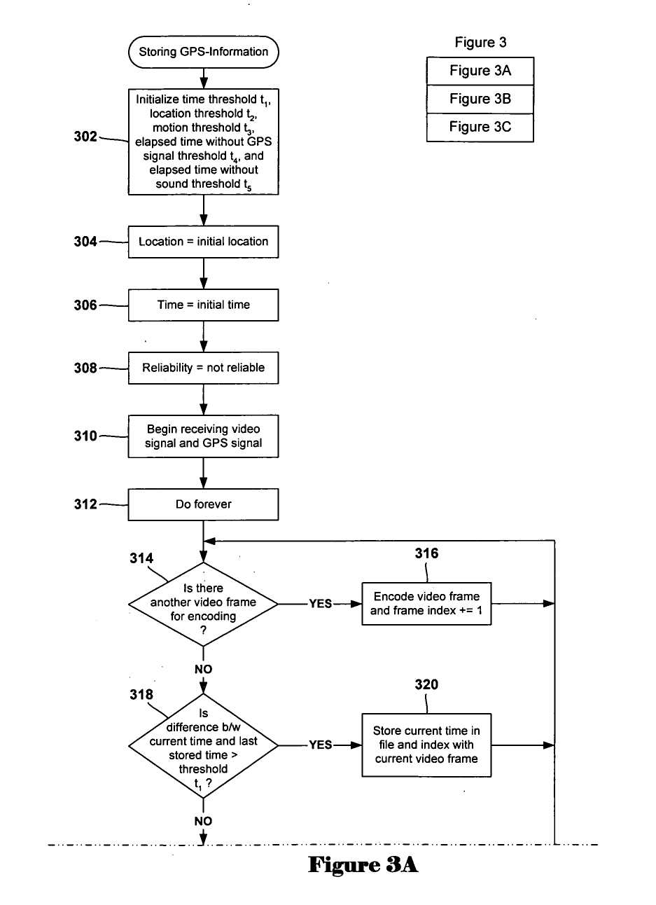

FIGS. 3A-3C show a control-flow diagram for a routine “storing GPS-information” performed by a video recorder that represents one embodiment of the present invention. In step 302, initial threshold values are set, including time threshold t₁, location threshold t₂, motion threshold t₃, elapsed-time-without-a-GPS-signal threshold t₄, and elapsed-time-without-a-sound threshold t₅. In step 304, an initial location is set. In step 306, an initial time is set. In step 308, the reliability of the GPS signal is set to “Not Reliable.” In step 310, a video signal and GPS information are received. In step 312, the following steps are performed forever. When, in step 314, there is a new video frame advanced, control is passed to step 316 where the video frame is encoded and the video index is advanced, and control is then passed back to step 314. Otherwise, when in step 318, the difference between the current time and the last stored time exceeds time threshold t₁, control is passed to step 320 where the current time is stored in the file and indexed with the current video frame. Note that either, or both, the time and the location can be stored in the file in step 320 and in other subsequent steps involving storage of information. Control is passed from step 320 to step 314. Otherwise, when in step 322, the difference between the current location and the last stored location exceeds location threshold t₂, control is passed to step 324 where the current location is stored into the file and indexed with the current video frame, and control is then passed back to step 314. Otherwise, when in step 326, the current motion exceeds the current motion threshold t₃, control is passed to step 328 where the current time and location are stored into the file and indexed with the current video frame, and control is then passed back to step 314. Otherwise, when in step 330, the amount of elapsed time without a GPS signal exceeds the time-without-a-GPS-signal threshold t₄, control is passed to step 332 where the current time and location are stored into the file and indexed with the current video frame, and control is then passed back to step 314. Otherwise, when in step 334, the amount of elapsed time without a sound on the video-signal track exceeds the time-without-a-sound-signal threshold t₅, control is passed to step 336 where the current time and location are stored into the file and indexed with the current video frame, and control is then passed back to step 314. Otherwise, when in step 338 the video-recorder user has activated a video-recorder-user-controlled storing-event trigger, control is passed to step 340 where the current time and location are stored into the file and indexed with the current video frame, and control is then passed back to step 314. Otherwise, when in step 342, another event of interest has occurred, control is passed to step 344 where the current time and location are stored into the file and indexed with the current video frame, and control is then passed back to step 314. Otherwise, when in step 346 a termination event has occurred, the control-flow diagram ends. Otherwise, control is passed back to step 314.

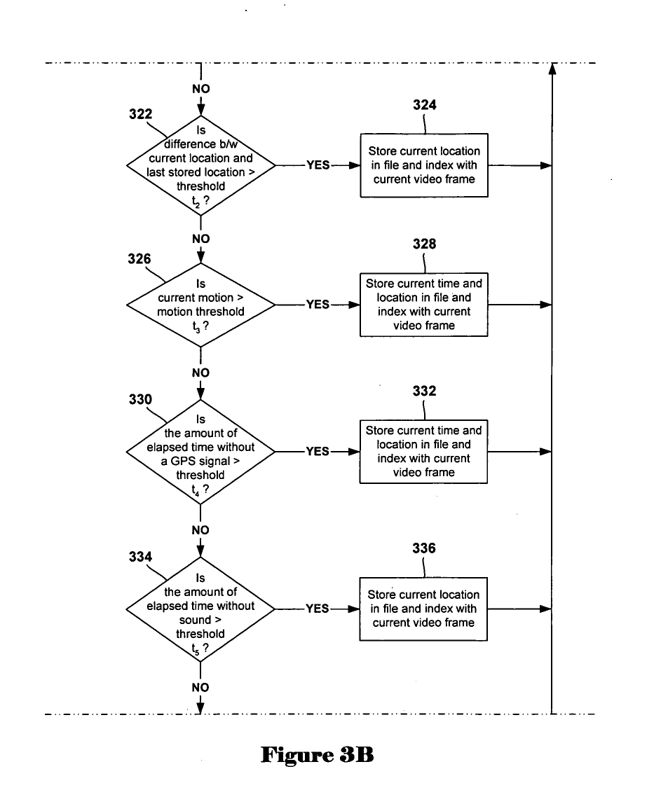

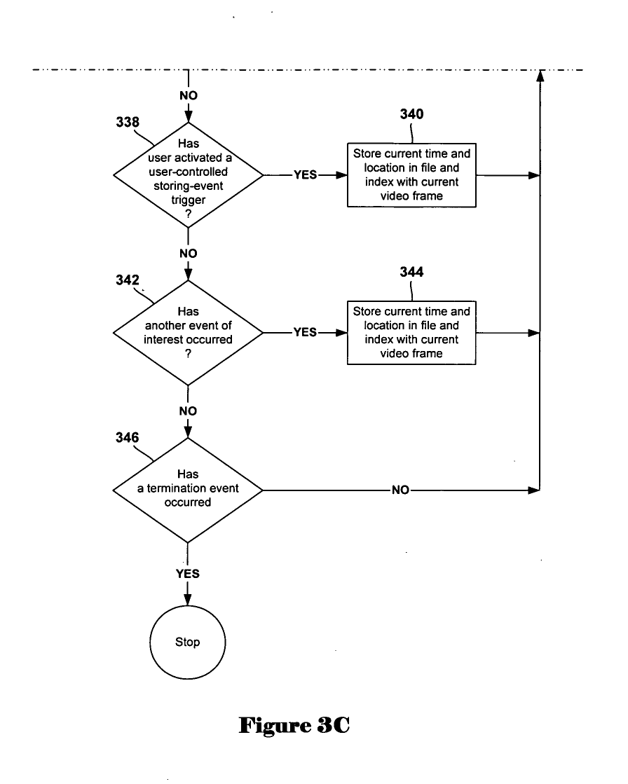

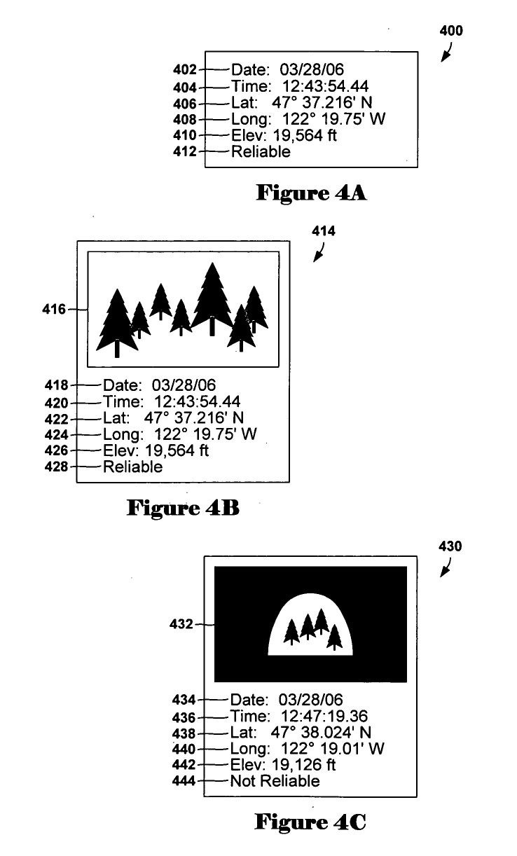

FIG. 4A illustrates a GPS-information display for a selected video frame that represents one embodiment of the present invention. GPS-information display 400 includes the date 402, time 404, latitude 406, longitude 408, elevation 410, and a reliability indicator 412 for a selected video frame. GPS-information display 400 can be accessed by a video-recorder user for any frame of a corresponding video recording recorded on the video recorder and stored to a video-signal file.

An image of a recorded video frame from a video recording can be included with the displayed GPS information for the recorded and stored video frame. FIG. 4B illustrates a GPS-information display that includes an image of a selected video frame and reliable corresponding GPS information that represents one embodiment of the present invention. GPS-information display 414 includes an image 416 of a selected video frame, as well as the date 418, time 420, latitude 422, longitude 424, elevation 426, and a reliability indicator 428 for the selected video frame. Reliability indicator 428 indicates that the GPS information is reliable.

FIG. 4C illustrates a GPS-information display that includes an image of a selected video frame and unreliable corresponding GPS information that represents one embodiment of the present invention. GPS-information display 430 includes an image 432 of a selected video frame, as well as the date 434, time 436, latitude 438, longitude 440, elevation 442, and a reliability indicator 444 for the selected video frame. The image 432 was recorded from inside a cave looking out. The reliability indicator 444 in GPS-information display 430 indicates that the GPS information displayed in GPS-information display 430 is unreliable because a storing event occurred most likely occurred while the GPS signal was inaccessible while inside the cave. The GPS information displayed may be the GPS information from a previous GPS reading, or an interpolated GPS reading based on the GPS information from one or more previous GPS readings and one or more subsequent GPS readings. In one embodiment of the present invention, an interpolation algorithm can be applied to the GPS information associated with storing events, with GPS information associated with storing events with high GPS-reading reliability given more weight during interpolation.

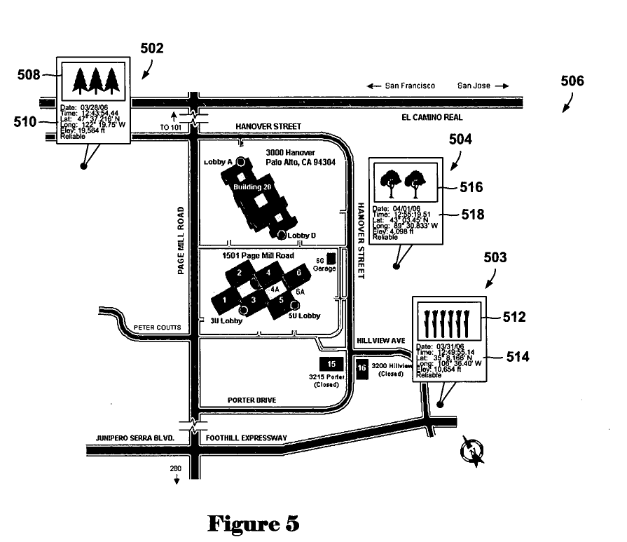

Multiple GPS-information displays can be overlain on a map to show a temporal and spatial progression of a video recording. FIG. 5 illustrates three GPS-information displays overlain on a map that represents one embodiment of the present invention. GPS-information displays 502-504 are overlain on a map 506 of the Palo Alto Campus of Hewlitt-Packard Company. GPS-information display 502 includes a first image 508 of a video frame recorded south of Hanover Street and the corresponding GPS information 510 for the first image 508. GPS-information display 503 includes a second image 512 of a video frame and the corresponding GPS information 514 for a video frame recorded near the intersection of Hillview Avenue and the Foothill Expressway a few minutes after the video frame shown in GPS-information display 502. GPS-information display 504 includes a third image 516 and the corresponding GPS information 518 for a video frame recorded east of Hanover Street a few minutes after the video frame shown in GPS-information display 503.

Collectively, GPS-information displays 502-504 show a temporal and spatial progression of the recording of a video recording. Each GPS-information display shows a particular time and location where a representative video frame from a video recording was recorded. Many more GPS-information displays can be overlaid onto maps of various scopes, depending on the number of locations used and the distance between the locations. The number of GPS-information displays overlain on a map can be determined by a video-recorder user or can be determined based on temporal or spatial threshold values. For example, a GPS-information display for a video frame can be set to be overlaid onto a map at a regular time interval, including every ten seconds, every ten hours, every ten days, or some other time interval. Alternatively, a GPS-information display for a video frame can be set to be overlaid onto a map whenever a distance interval is exceeded from a baseline location, such as a starting location or other established location. Also, a GPS-information display for a video frame can be selected by a video-recorder user to be overlaid onto a map.

In an alternate embodiment of the present invention, a video recording with corresponding GPS information can be played while overlaid on a map. A GPS-information display can include a display of a video recording and the corresponding GPS-information instead of an image of a selected video frame, as shown in FIGS. 4B-5. The location of the video recording and corresponding GPS-information display change position on a map in relation to the spatial GPS information for the video recording.

Additional modifications within the spirit of the invention will be apparent to those skilled in the art. For example, other GPS-information-activation events can be used to coordinate the storing of GPS information by the video recorder. Accordingly, additional event-of-interest inputs may be necessary to provide information for determining when a storing event has occurred. Various threshold levels can be used for determining GPS-information-activation events. Threshold levels can be set by the manufacturer and/or can be set or reset by a video-recorder user. The multiplexer may include additional inputs for other information to be included in the output signal. GPS information can be stored as many different types of metadata, in many different types of container formats. The methods and systems described above for incorporating GPS information video recordings can be used for other types of data recordings besides video recordings.

The foregoing detailed description, for purposes of illustration, used specific nomenclature to provide a thorough understanding of the invention. However, it will be apparent to one skilled in the art that the specific details are not required in order to practice the invention. Thus, the foregoing descriptions of specific embodiments of the present invention are presented for purposes of illustration and description; they are not intended to be exhaustive or to limit the invention to the precise forms disclosed. Obviously many modifications and variation are possible in view of the above teachings. The embodiments were chosen and described in order to best explain the principles of the invention and its practical applications and to thereby enable others skilled in the art to best utilize the invention and various embodiments with various modifications as are suited to the particular use contemplated.

1-18. (canceled)

19. A global-positioning-system-capable data recorder comprising:
a data encoder that encodes received data for output to a data track and storage into a file at a first location;
a global-positioning-system encoder that encodes received global-positioning-system data for output to a global-positioning-system-data track and storage into the file at a second location; and
decision logic that selects global-positioning-system data for output.

20. The global-positioning-system-capable data recorder of claim 19 further including a multiplexer that receives encoded data from the data encoder and encoded global-positioning-system data from the global-positioning-system encoder and outputs a multi-track signal that is stored into the file.

21. The global-positioning-system-capable data recorder of claim 19 wherein the data encoded by the data encoder and global-positioning-system data encoded by the global-positioning-system encoder are commonly indexed.

22. The global-positioning-system-capable data recorder of claim 19 wherein the decision logic selects currently received global-positioning-system data for output when more than a threshold amount of time has elapsed since global-positioning-system data was last output.

23. The global-positioning-system-capable data recorder of claim 19 wherein the decision logic selects currently received global-positioning-system data for output when more than a threshold amount of distance has been traversed since global-positioning-system data was last output.

24. The global-positioning-system-capable data recorder of claim 19 wherein the decision logic selects currently received global-positioning-system data for output when reception of global-positioning-system data has resumed following a period when no global-positioning-system data has been received.

25. The global-positioning-system-capable data recorder of claim 19 wherein the decision logic selects currently received global-positioning-system data for output when sound on the current data received by the data encoder has resumed following a period when no sound has been received.

26. The global-positioning-system-capable data recorder of claim 19 wherein the decision logic selects currently received global-positioning-system data for output when a data-recorder user activates a global-positioning-system-data-storing trigger.

27. The global-positioning-system-capable data recorder of claim 19 wherein the decision logic selects currently received global-positioning-system data for output when more than a threshold amount of motion has been detected in the data received by the data encoder.

28. A global-positioning-system-capable video recorder comprising:
a video encoder that encodes received video frames for output to a video-signal track and storage into a file at a first location;
a global-positioning-system encoder that encodes received global-positioning-system data for output to a global-positioning-system-data track and storage into the file at a second location; and
decision logic that selects global-positioning-system data for output.

29. The global-positioning-system-capable video recorder of claim 28 further including a multiplexer that receives encoded video frames from the video encoder and encoded global-positioning-system data from the global-positioning-system encoder and outputs a multi-track signal that is stored into the file.

30. The global-positioning-system-capable video recorder of claim 28 wherein the video frames encoded by the video encoder and global-positioning-system data encoded by the global-positioning-system encoder are commonly indexed.

31. The global-positioning-system-capable video recorder of claim 28 wherein the decision logic selects currently received global-positioning-system data for output when more than a threshold amount of time has elapsed since global-positioning-system data was last output.

32. The global-positioning-system-capable video recorder of claim 28 wherein the decision logic selects currently received global-positioning-system data for output when more than a threshold amount of distance has been traversed since global-positioning-system data was last output.

33. The global-positioning-system-capable video recorder of claim 28 wherein the decision logic selects currently received global-positioning-system data for output when reception of global-positioning-system data has resumed following a period when no global-positioning-system data has been received.

34. The global-positioning-system-capable video recorder of claim 28 wherein the decision logic selects currently received global-positioning-system data for output when sound on the current video frame received by the video encoder has resumed following a period when no sound has been received.

35. The global-positioning-system-capable video recorder of claim 28 wherein the decision logic selects currently received global-positioning-system data for output when a video-recorder user activates a global-positioning-system-data-storing trigger.

36. The global-positioning-system-capable video recorder of claim 28 wherein the decision logic selects currently received global-positioning-system data for output when more than a threshold amount of motion has been detected in a number of video frames received by the video encoder.
